(19) United States
(12) Patent Application Publication
(10) Pub. No.: US 2020/0104766 A1
(43) Pub. Date: Apr. 2, 2020

(54) CORPORATE GROUP MANAGEMENT METHOD AND SYSTEM

(71) Applicant: SUMITOMO MITSUI BANKING CORPORATION, Tokyo (JP)

(72) Inventor: Kiyonori UGAJIN, Tokyo (JP)

(21) Appl. No.: 16/495,820

(22) PCT Filed: Mar. 30, 2017
(86) PCT No.: PCT/JP2017/013414

§ 371 Date: Sep. 19, 2019

(51) Int. Cl. G06Q 10/06

(52) U.S. Cl. CPC G06Q 10/0631

(57) ABSTRACT

Data management for a business client and group companies thereof is manually executed. When a capital tie between companies is changed, supervising offices for the respective companies are responsible for reflecting the change in data about the companies and thus cooperate with one another. A computing system centrally manages the data about the business client and the group companies thereof to allow the supervising offices to share the data. When the capital tie between the companies is changed, each of the supervising offices is made to check the contents for the change based on a relationship between the supervising office and a business client thereof and a relationship between a branch office and a business client thereof. Determination information about whether corporate group data needs to be updated or not is provided to allow corporate group data to be updated to a latest status.

### TECHNICAL FIELD

The present embodiment relates to a corporate group management method and system. More specifically, the present embodiment relates to a method and system for centrally managing data about a business client and group companies thereof which data is used in a financial institution or the like, to allow supervising offices to share the data, enabling accurate and efficient understanding of change information about capital ties among corporations and the like. In particular, the present embodiment relates to a method and a system for making, in a case where capital ties among companies or the like are changed, each of the supervising offices checks the contents for the change based on a relationship between the supervising office and the business client thereof and a relationship between a branch office and a business client thereof, and providing determination information about whether corporate group data needs to be updated or not, to allow the corporate group data to be updated to a latest status.

### BACKGROUND ART

In corporate transactions in a financial institution, grouping globally client companies has led to generalization of global transactions with aggregates of corporations as well as transactions with individual companies. In a financial institution, executives and departmental personnel need to understand totalized numerical data about various transactions of the client companies as the entire corporate group, in order to make the company's managerial determinations and decisions. For managerial accounting, the totalized numerical data about the corporate group is understood, and a variety of information about the transaction corporate group is collected and analyzed according to purposes to allow the status of and problems with a transaction portfolio to be understood.

For example, in managerial accounting of a business client, the financial institution needs to know the statuses of operations such as deposits, loans, and exchanges at domestic and overseas hubs. Moreover, financial conditions need to be grasped not only for the inside of the business client corporation but also for group companies operationally affected by capital ties and the like. In this manner, there has been a demand to use, for the managerial accounting of the business client, a variety of information extensively dispersed within the business client corporation and within the group companies.

On the other hand, a branch office (supervising office) of the financial institution trading with the business client is not necessarily identical to a supervising office trading with the group companies of the business client. Furthermore, many group companies may be present, and the supervising offices for the respective group companies may be located in different countries. In this case, data (client data) related to the business client and each group company is scattered in databases installed in the respective countries for management. Thus, there is a need for a method and a system for centrally managing data about the business client and the group companies thereof to allow the supervising offices to share the data.

### SUMMARY OF INVENTION

However, at present, data management for the business client and the group companies thereof is manually conducted, requiring a teller (receptionist) to deal with a large amount of workload. Furthermore, several tens of or several hundred group companies may be present, and errors or omissions may result from an attempt to know, by manual data management, the statuses of transactions for operations such as deposits, loans, and exchanges at domestic and overseas hubs. Moreover, the capital tie between companies or the like is often changed (for example, the capital tie between the companies may be lost or a new capital tie-up may be formed), and every change needs to be reflected in the data about the companies. In this manner, sufficient data management for the business client and the group companies thereof including maintenance of data is important in making credit decisions. In particular, in a case where the capital tie between companies or the like is changed, the supervising offices for the respective companies are responsible for reflecting the change in the data about the companies, and thus cooperate with each other (for example, the tellers contact each other to check whether the change in capital tie or the like is correct). However, branch offices of the financial institution serving as supervising offices are located in different countries, and the cooperation between the supervising offices are not easy.

The present embodiment provides the technique to centrally manage data about a business client and group companies thereof which data is used in a financial institution or a financial holding company group to allow supervising offices to share the data. In particular, the present embodiment provides the technique to make, in a case where, for example, the capital tie between a business client of a financial institution or the like and a group company of the client is changed, the supervising offices check the contents for the change to reflect the correct contents for the change in the data about the companies. Note that the present embodiment is directed to the relationship between not only a financial institution, but also the entire financial holding company group including the financial institution and affiliated companies, and a business client and group companies thereof. Furthermore, data sharing is not limited to the supervising offices but is assumed to be intended for any branch offices of the financial institution and the financial holding company group that are involved in transactions.

In the embodiment, a server computer is provided that centrally manages data about a business client and group companies thereof which data is used in a financial institution or a financial holding company group including the financial institution, the server computer being configured:

to receive relationship change data related to contents for a change in a relationship between the business client and each of the group companies,

to search for supervising offices in the financial institution or the financial holding company group for the business client and the group companies respectively based at least on the relationship change data and client data, the client data being data related to contracted clients including the business client and the group companies, the financial institution or the financial holding company group dealing with the contracted clients,

to create group identification data used to inquire of each of the supervising offices about whether the contents for the change are correct or not, based at least on the relationship change data and the client data, the group name identification data being data related to contents for the relationship between the business client and each of the group companies before and after the change,

to transmit the group identification data to terminals of the supervising offices,

to receive check result data from the terminals of the supervising offices, the check result data being data related to results of checks on the group identification data by the supervising offices,

to determine, based at least on the check result data, whether each of the supervising offices approves the group identification data, and

to update group data based at least on the group identification data in a case where each of the supervising offices approves the group identification data, the group data being data related to a current relationship between the business client and each of the group companies.

Furthermore, in the server computer according to the preceding paragraph, transmitting the group identification data to the terminals of the supervising offices includes providing a Web site to the terminals of the supervising offices, and

a user interface indicating the relationship between the business client and each of the group companies is displayed at the Web site to make personnel of each of the supervising offices check the group identification data and input the check result data.

Moreover, in the server computer according to the preceding paragraph, receiving the relationship change data includes receiving the relationship change data from a computer managed by an institution other than the financial institution and the financial holding company group or from the terminals of the supervising offices via the Web site.

In the server computer according to the preceding third paragraph, the supervising offices are located in different countries, and the client data about the business client and the group companies is held by computers in countries where the supervising offices corresponding to the business client and the group companies are located.

Furthermore, the server computer according to the preceding fourth paragraph is further configured:

to receive specification data specifying a relationship between the business client and each of the group companies, from a first computer utilized by personnel of the financial institution or the financial holding company group, and

to extract the business client and the group company having a particular relationship based on the specification data and the group data.

The server computer according to the preceding fourth paragraph is further configured:

to receive specification data specifying a relationship between the business client and each of the group companies, from a first computer utilized by personnel of the financial institution or the financial holding company group; and

to extract the business client and the group company having a particular relationship based on the specification data and the group data.

In the server computer according to the preceding fifth paragraph, the relationship between the business client and each of the group companies in the relationship change data and the group data is related to one of capital, stock issuer/major stockholder, human relationship, supply, distribution, equity method company, investment, and substantial control.

Furthermore, in another embodiment, a method is provided that is executed by a server computer that centrally manages data about a business client and group companies thereof which data is used in a financial institution or a financial holding company group including the financial institution, the method including the steps of:

the server computer receiving relationship change data related to contents for a change in a relationship between the business client and each of the group companies,

the server computer searching for supervising offices in the financial institution or the financial holding company group for the business client and the group companies respectively based at least on the relationship change data and client data, the client data being data related to contracted clients including the business client and the group companies, the financial institution or the financial holding company group dealing with the contracted clients

the server computer creating group identification data used to inquire of each of the supervising offices about whether the contents for the change are correct or not, based at least on the relationship change data and the client data, the group name identification data being data related to contents for the relationship between the business client and each of the group companies before and after the change,

the server computer transmitting the group identification data to terminals of the supervising offices,

the server computer receiving check result data from the terminals of the supervising offices, the check result data being data related to results of checks on the group identification data by the supervising offices,

the server computer determining, based at least on the check result data, whether each of the supervising offices approves the group identification data, and

in a case where each of the supervising offices is determined to approve the group identification data, the server computer updating group data based at least on the group identification data, the group data being data related to a current relationship between the business client and each of the group companies.

Moreover, in yet another embodiment, a computer program is provided that is executed by a server computer that centrally manages data about a business client and group companies thereof which data is used in a financial institution or a financial holding company group including the financial institution, the computer program causing, in a case of being executed by the server computer, the server computer to execute the steps of:

receiving relationship change data related to contents for a change in a relationship between the business client and each of the group companies,

searching for supervising offices in the financial institution or the financial holding company group for the business client and the group companies respectively based at least on the relationship change data and client data, the client data being data related to contracted clients including the business client and the group companies, the financial institution or the financial holding company group dealing with the contracted clients

creating group identification data used to inquire of each of the supervising offices about whether the contents for the change are correct or not, based at least on the relationship change data and the client data, the group name identification data being data related to contents for the relationship between the business client and each of the group companies before and after the change,

transmitting the group identification data to terminals of the supervising offices,

receiving check result data from the terminals of the supervising offices, the check result data being data related to results of checks on the group identification data by the supervising offices,

determining, based at least on the check result data, whether each of the supervising offices approve the group identification data, and

in a case where both the supervising offices are determined to approve the group identification data, updating group data based at least on the group identification data, the group data being data related to a current relationship between the business client and each of the group companies.

### Advantageous Effects of the Invention

As described above, according to the present embodiment, a computing system centrally manages the data about the business client and the group companies thereof which data is used in the financial institution or the financial holding company group to allow the supervising offices to share the data. This allows accurate and efficient understanding of change information about capital ties among enterprises or the like. In particular, in a case where, for example, the capital tie between the companies is changed, each of the supervising offices is made to check the contents for the change based on a relationship between the supervising office and the business client thereof and a relationship between a branch office and a business client thereof. Determination information about whether corporate group data needs to be updated or not is provided to allow the corporate group data to be updated to a latest status. Furthermore, the latest corporate group data constantly updated as described above is utilized to allow the financial institution or the financial holding company group to know the statuses of transactions of the business client and all the group companies thereof.

### BRIEF DESCRIPTION OF DRAWINGS

FIG. 1 is a diagram illustrating a configuration of an entire system according to the present embodiment;

FIG. 2 is a diagram illustrating a configuration of a group management server that is a main server in a system according to the present embodiment;

FIG. 3 is a flowchart illustrating a group identification process according to the present embodiment;

FIG. 4 is a diagram illustrating data stored in a client data storage unit according to the present embodiment;

FIG. 5 is a diagram illustrating data stored in a relationship change data storage unit according to the present embodiment;

FIG. 6 is a diagram illustrating data stored in a group identification data storage unit according to the present embodiment;

FIG. 7 is a diagram illustrating data stored in a check result data storage unit according to the present embodiment;

FIG. 8 is a diagram illustrating data stored in a group data storage unit according to the present embodiment;

FIG. 9 is a diagram illustrating a user interface for checking of group identification candidates (for major company supervising offices) according to the present embodiment; and

FIG. 10 is a diagram illustrating a user interface for checking of group identification candidates (for associated company supervising offices) according to the present embodiment.

### DESCRIPTION OF EMBODIMENTS

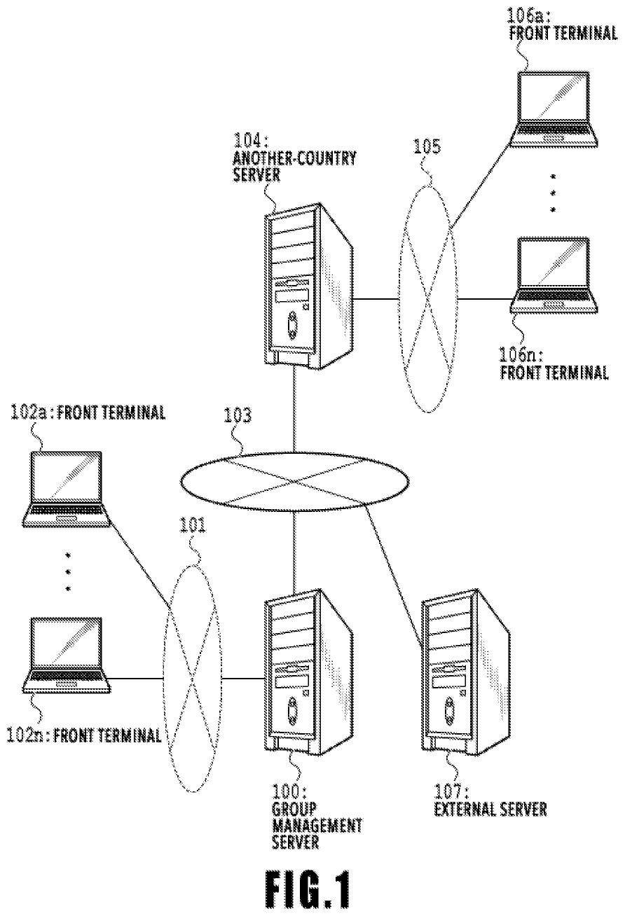

Now, a group management system according to the present embodiment will be described with reference to the accompanied drawings. FIG. 1 is a diagram illustrating a configuration of the entire system according to the present embodiment. In FIG. 1, a group management server 100 that is a main server of the system installed in a data center is configured to communicate via a network 101 (for example, an intranet) with front terminals 102a to 102n (hereinafter collectively referred to as the “front terminal 102”) used by a teller in a country A (for example, Japan). Furthermore, the group management server 100 is configured to communicate with an another-country server 104 and an external server 107 via a network 103 (for example, Internet). The another-country server 104 is also configured to communicate via a network 105 (for example, an intranet) with front terminals 106a to 106n (hereinafter collectively referred to as the “front terminal 106”) used by the teller in a country B (for example, United States). Note that, in FIG. 1, the group management server 100 and the like are each represented as one server computer but can be constructed as a distributed computing system including a plurality of server computers. Furthermore, FIG. 1 illustrates the front terminals in only two countries. However, actually, the front terminals can be located in a large number of financial institutions in a large number of countries. Note that the “financial institution” as used herein includes the financial holding company group and affiliated companies.

The external server 107 is a server computer managed by an institution other than each financial institution. The external server 107 manages change data (relationship change data) about capital ties among companies and provides the relationship change data to each financial institution.

The group management server 100 is a server computer managed by each financial institution in the country A and holding client data for the country A. Furthermore, the group management server 100 is an execution entity for a group identification process according to the present invention. The group management server 100 receives relationship change data about companies from the external server 107, and inquires of supervising offices for the companies involved in the change about whether the contents for the change are correct or not. In a case where all the supervising offices approve the contents for the change, the group management server 100 reflects the contents for the change in group data indicating the relationship between the companies.

The front terminal 102 and the front terminal 106 are used by the teller in the respective countries. The teller in each country checks, via the front terminal 102 and the front terminal 106, the contents for a change in the relationship between a company for which the teller's office serves as a supervising office and each of the group companies, and registers the results of the check. Note that the front terminal 102 and the front terminal 106 may be hereinafter collectively referred to as the “front terminal”.

The another-country server 104 is a server computer managed by each financial institution in the country B and holding client data for the country B. The another-country server 104 in FIG. 1 is illustrated as serving as a relay server relaying information from the group management server 100 in the country A to the front terminal 106 in the country B. However, the another-country server 104 can be provided with the same functions as those of the group management server 100 to perform a group name identification process described below. Which server executes the group name identification process can be changed depending on, for example, which country the target supervising office belongs to. For example, in a case where all the supervising offices for the companies are located in the country B, the another-country server 104 installed in the country B can perform the group name identification process.

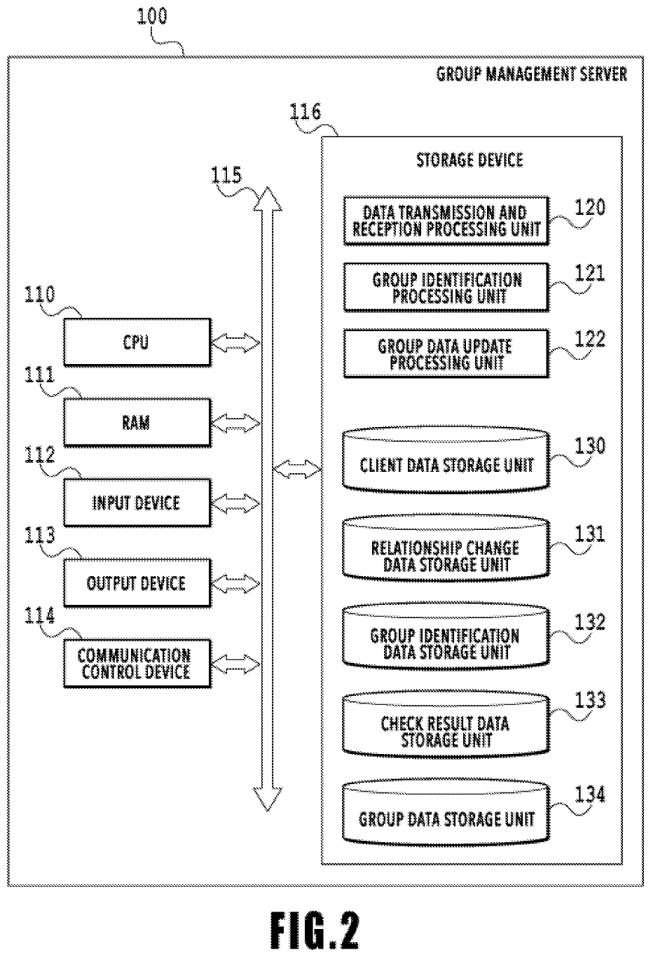

Now, a configuration of the group management server 100 will be described in detail. FIG. 2 is a diagram illustrating a configuration of a group management server that is a main server in a system according to the present embodiment. Note that, in FIG. 2, a single server computing system is assumed, with only required components illustrated. The group management server 100 includes a CPU 110, a RAM 111, an input device 112, an output device 113, a communication control device 114, and a storage device 116 that are connected together via a system bus 115. The storage device 116 is implemented in a nonvolatile storage medium (ROM, HDD, or the like), and includes a program storage area in which a software program associated with a transfer process is stored and a data storage area in which data handled by the software program is stored. Each processing unit of the program storage area described below is actually an independent software program or a routine or a component thereof stored in the storage device 116. In a case of being executed, each processing unit is invoked from the storage device 116 by the CPU 110 and loaded into a work area of the RAM 111 to perform functions while appropriately accessing a database.

The software program stored in the program storage area in the storage device 116 in FIG. 2 includes a data transmission and reception processing unit 120, a group identification processing unit 121, and a group data update processing unit 122; only the processing units associated with the present embodiment are enumerated. These processing units are performed by the CPU 110.

The data storage area in the storage device 116 in FIG. 2 includes a client data storage unit 130, a relationship change data storage unit 131, a group identification data storage unit 132, a check result data storage unit 133, and a group data storage unit 134; only the storage units associated with the present embodiment are enumerated. Each of the storage units is a given storage area provided within the storage device 116.

Now, functions of the software programs stored in the storage device 116 in FIG. 2 will be described. The data transmission and reception processing unit 120 receives relationship change data from the external server 107 and stores the data in the relationship change data storage unit 131. Furthermore, the data transmission and reception processing unit 120 transmits created group identification data to the front terminal 102 and/or front terminal 106 in each supervising office to inquire of the supervising office about whether the contents for a change are correct or not. The data transmission and reception processing unit 120 receives check result data from each supervising office through the front terminal 102 and/or the front terminal 106 and stores the data in the check result data storage unit 133.

The group identification processing unit 121 in FIG. 2 acquires client data about each of the major company and associated companies involved in the change based on the received relationship change data, and searches for supervising offices trading with the companies. Furthermore, the group identification processing unit 121 creates group identification data based on the relationship change data and the client data, and stores the group identification data in the group identification data storage unit 132. Note that the “major company” and the “associated companies” as used herein refer to companies having some kind of relationship with one another but that the major company is not necessarily a capital tie source or a parent company. The major company merely refers to a company serving as a reference. For example, in a case where a subsidiary is defined as a reference, the subsidiary is a major company and the parent company is an associated company.

The group data update processing unit 122 in FIG. 2 determines whether the contents for the change are approved by all the supervising offices, based on the check result data received from each supervising office. In a case where the contents for the change are approved by all the supervising offices, the group data update processing unit 122 reflects the contents for the change in the group data stored in the group data storage unit 134 and related to each company involved in the change.

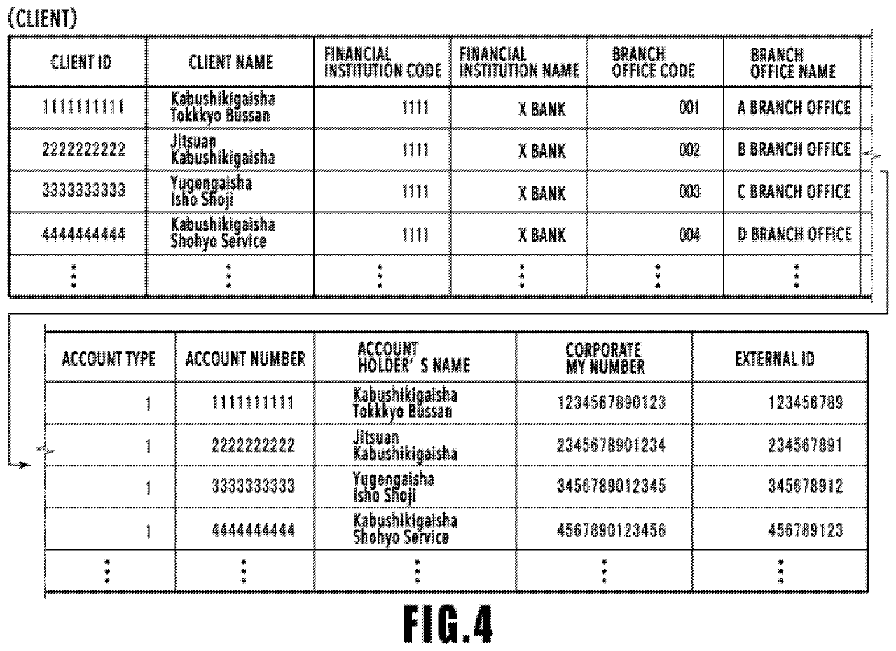

Now, the data stored in the storage device 116 in FIG. 2 will be described in detail. The client data storage unit 130 in FIG. 2 stores data related to contracted clients with which the financial institution deals. FIG. 4 is a diagram illustrating the data stored in the client data storage unit 130 according to the present embodiment.

The stored client data in FIG. 4 includes a “client ID” uniquely indicative of a client in the financial institution in each country, a “client name” indicative of the name of the client, a “financial institution code” uniquely indicative of a financial institution that provides a contracted account for the client, a “financial institution name” indicative of the name of the financial institution, a “branch office code” uniquely indicative of a branch office of the financial institution, a “branch office name” indicative of the name of the branch office, an “account type” uniquely indicative of the account type (account item) of the contracted account, an “account number” indicative of the account number of the contracted account, an “account holder's name” indicative of the name of the account holder of the contracted account, a “corporate my number” indicative of a National Tax Agency corporate number, and an “external ID” uniquely indicative of the client in the external server 107 providing the relationship change data.

The client data is master data held by the group management server 100 and the another-country server 104. The “client ID” in FIG. 4 is unique in the financial institution in each country and thus varies with country even in a case where the client ID is indicative of the same client (in other words, the financial institution in each country may assign the same ID to different clients). In FIG. 4, the branch office indicated by the combination of the “financial institution code” and the “branch office code” is a supervising office for the client indicated by the corresponding “client ID”. As the “corporate my number”, a corporate number can be stored that is issued by the National Tax Agency in a case where the client is a corporation in Japan. As the “account type”, a numerical value can be set that is indicative of the account type of the client's contracted account (for example, 1: savings account, 2: time deposit, 3: checking account, . . . ).

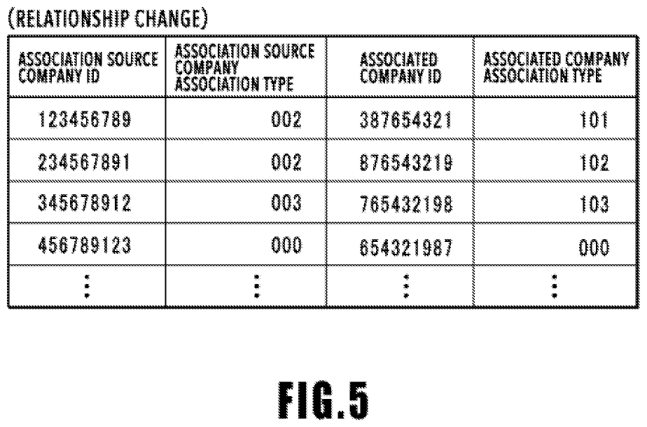

The relationship change data storage unit 131 in FIG. 2 stores data managed and provided by the external server 107 and indicating the contents for a change in the relationship between companies. FIG. 5 is a diagram illustrating the data stored in the relationship change data storage unit 131 according to the present embodiment.

The stored relationship change data in FIG. 5 includes an “association source company ID” uniquely indicative of an association source company involved in the change, “an association source company association type” indicative of the association type of the association source company, an “associated company ID” uniquely indicative of an associated company corresponding to the association source company, and “associated company association type” indicative of the association type of the associated company.

The relationship change data is transaction data managed by the external server 107. As each of the “association source company ID” and the “associated company ID” in FIG. 5, the corresponding “external ID” in the client data (FIG. 4) is set, allowing the relationship change data to be linked with the client data about the association source company or the associated company. The “association source company association type”, a numerical value can be set that is indicative of the association type of the association source company (for example, 000: no association, 001: capital tie source, 002: stock issuer, 003: human relationship source, 004: purchaser, 005: distributor, 006: guarantor, 007: equity method parent company, 008, investor, 009: substantial controller, . . . ). On the other hand, the corresponding “associated company association type”, a numerical value can be set that is indicative of the association type of the associated company (for example, 000: no association, 101: capital tie holder, 102: major stockholder, 103: human relationship holder, 104: supplier, 105: purchaser, 106, guarantee, 107: equity method affiliate, 108: investee, and substantial controlled company, . . . ). For the “association source company association type” and the “associated company association type”, “000” (no association) indicates that the companies had some relationship before the change but now have no relationship.

Note that the relationship change data in FIG. 5 is an example and may actually be data in various formats indicating the relationship between companies or allowing the relationship between the companies to be determined. The data allowing the relationship between companies to be determined is, for example, an “investment ratio”. An investment ratio of more than 50% indicates that the association source company can be determined to be an investor, whereas the associated company can be determined to be an investee.

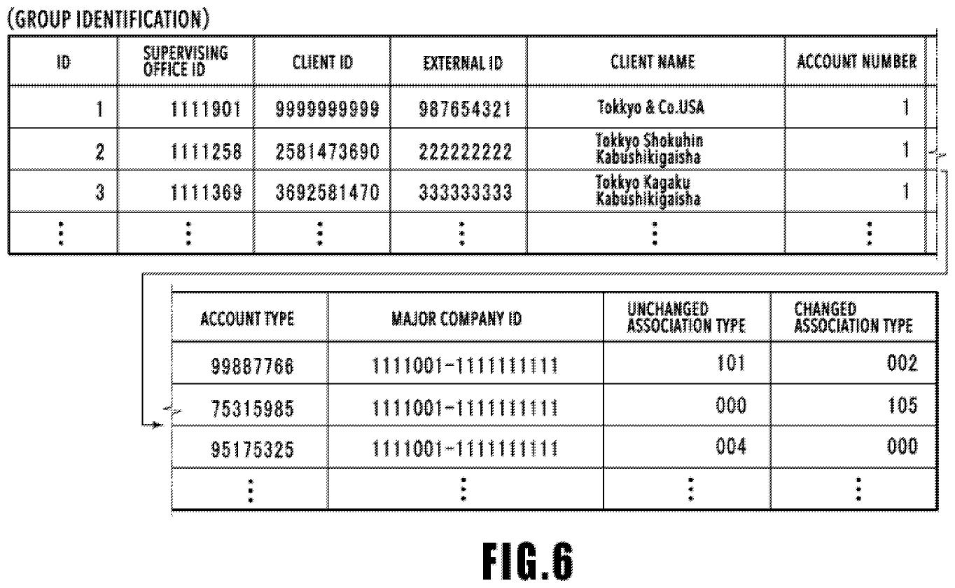

The group identification data storage unit 132 in FIG. 2 stores data indicating the relationship between companies before and after a change and created to allow each supervising office to check the data. FIG. 6 is a diagram illustrating the data stored in the group identification data storage unit 132 according to the present embodiment.

Data stored as the group identification data in FIG. 6 includes an “ID” uniquely indicative of this data, a “supervising office code” uniquely indicative of a supervising office dealing with a client, a “client ID” uniquely indicative of the client in the financial institution in each country, an “external ID” uniquely indicative of the client in the external server 107, a “client name” indicative of the name of the client, an “account type” uniquely indicative of the account type (account item) of the contracted account of the client, an “account number” indicative of the account number of the contracted account, a “major company ID” uniquely indicative of a major company involved in the change, an “unchanged association level” indicative of the association type of the client before the change, and a “changed association level” indicative of the association type of the client after the change.

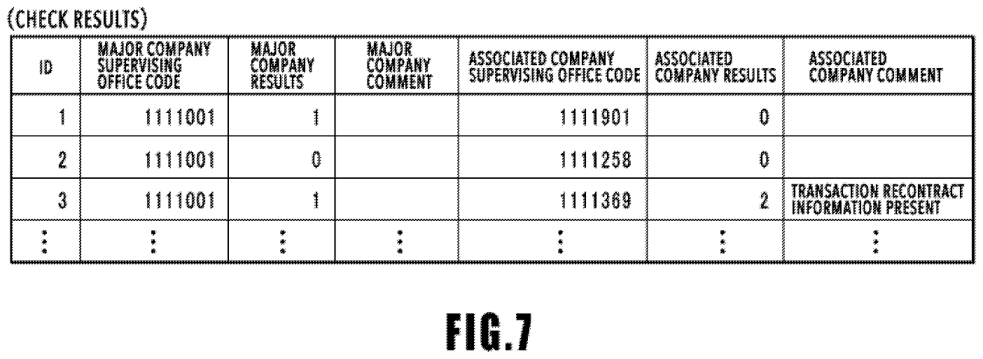

The group identification data is transaction data created based on the relationship change data. The “ID” in FIG. 6 is, for example, a sequence number, and the same value as that for an “ID” in the check result data (FIG. 7) described below is set for the “ID” in FIG. 6 to allow the group identification data to be linked with the check result data. The “client ID”, the “external ID”, the “client name”, the “account type”, and the “account number” are similar to the data items with the same names in the client data (FIG. 4). Note that FIG. 6 is a diagram indicating the relationship between associated companies indicated by the “client ID” and major companies indicated by the “major company ID” according to an embodiment. In another embodiment, an ID indicative of a major company may be set in the “client ID”, and instead of the “major company ID”, an “associated company ID” can be provided that is indicative of an associated company.

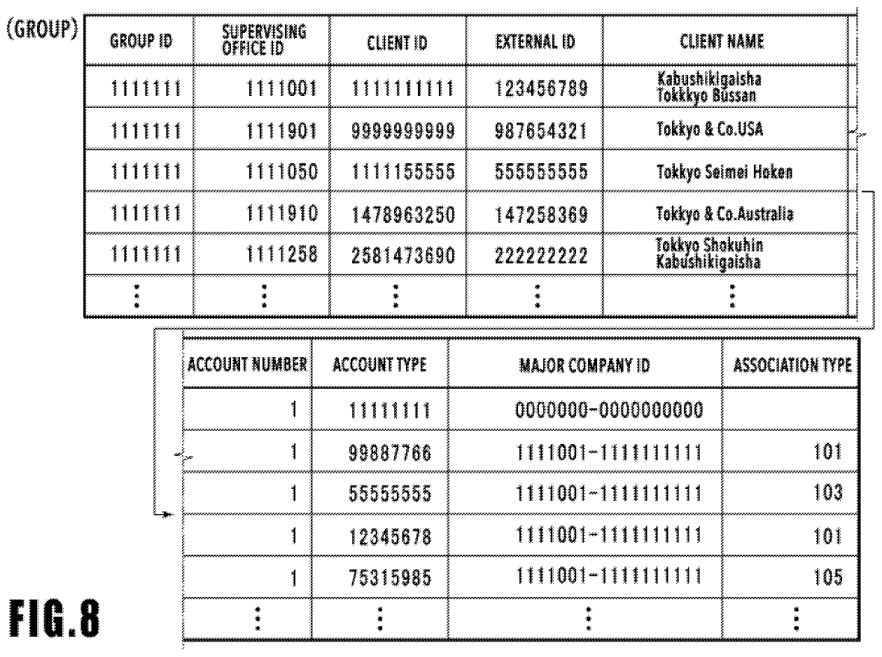

The “major company ID” in FIG. 6 is an ID uniquely indicative of a major company in a case where the client indicated by the “client ID” is designated as an associated company. The “major company ID” is created by, for example, combining the “supervising office code” with the “client ID”, as illustrated in FIG. 6. This is because the financial institution in each country may assign the same “client ID” even to different clients as described above. Thus, a combination of the “supervising office code” and the “client ID” enables the client to be uniquely identified and allows the client data (FIG. 4) or the group data (FIG. 8) to be linked with the group identification data. Note that, in another embodiment, the client can be uniquely identified using only the “client ID”.

The “unchanged association type” in FIG. 6 is the association type of the associated company before the change (current association type), and thus, the “supervising office code” and the “client ID” are used as search keys to acquire and set the “association type” in the group data (FIG. 8), described below. On the other hand, in the “changed association type”, the “association source company association type” or the “associated company association type” in the relationship change data (FIG. 5) is set. Which of the “association source company association type” and the “associated company association type” is set depends on which of the association source company and the associated company is defined as a major company or a corresponding associated company. For example, in a case where the association source company is defined as a major company, the associated company is defined as the corresponding associated company. Thus, the “associated company association type” is set in the “changed association type” in FIG. 6.

The check result data storage unit 133 in FIG. 2 stores data related to the results of a check on the group identification data (FIG. 6) by each supervising office (whether the contents for the change are correct or not). FIG. 7 is a diagram illustrating the data stored in the check result data storage unit 133 according to the present embodiment.

The stored check result data in FIG. 7 can include an “ID” uniquely indicative of this data and the group identification data (FIG. 6), a “major company supervising office code” uniquely indicative of a supervising office for the major company, “major company results” indicative of the results of a check by the supervising office for the major company, a “major company comment” indicative of a comment on the check results made by the supervising office for the major company, an “associated company supervising office code” uniquely indicative of a supervising office for the associated company, “associated company results” indicative of the results of a check by the supervising office for the associated company, and an “associated company comment” indicative of a comment on the check results made by the supervising office for the associated company.

The check result data is transaction data input, via the front terminal 102 or the front terminal 106, by the teller of the supervising office for each of the major company and the associated company. The same value as that for the “ID” in the group identification data (FIG. 6) is set in the “ID” in FIG. 7 to allow the check result data to be linked with the group identification data. In the “major company results” and the “associated company results”, a numerical value indicative of the check results (for example, 0: unchecked, 1: approved, 2: disapproved, 3: undecided, . . . ) can be set.

The group data storage unit 134 in FIG. 2 stores data indicative of the current relationship between the companies. FIG. 8 is a diagram illustrating the data stored in the group data storage unit 134 according to the present embodiment.

The stored group data in FIG. 8 includes a “group ID” uniquely indicative of a group of companies, a “supervising office code” uniquely indicative of a supervising office dealing with the client, a “client ID” uniquely indicative of the client in the financial institution in each country, an “external ID” uniquely indicative of the client in the external server 107, a “client name” indicative of the client's name, an “account type” uniquely indicative of the account type (account item) of a contracted account of the client, an “account number” indicative of the account number of the contracted account, a “major company ID” uniquely indicative of a major company in a case where the client indicated by the “client ID” is defined as an associated company, and an “association type” indicative of the type of the association between the client and the major company.

The group data is master data managed to maintain the latest state of the relationship between the companies. In terms of the relationship, clients having the same “group ID” in FIG. 8 mean to belong to the same group. The “supervising office code”, the “client ID”, the “external ID”, the “client name”, the “account type”, and the “account number” are similar to data items with the same names in the group identification data (FIG. 6).

The “major company ID” in FIG. 8 is an ID uniquely indicative of a major company in a case where the client indicated by the “client ID” is an associated company.

Note that, in a case where the client indicated by the “client ID” is a major company, setting dummy data such as “0000000-0000000000” allows the major company to be identified among clients with the same “group ID”. For example, the relationship between data with a group ID of “1111111” in FIG. 8 is such that a client with a “client ID” of “1111111111” is a major company, and the other clients are associated companies.

The following can be set in the “association type” in FIG. 8: a numerical value indicative of the association type of association of an associated company with the major company indicated by the “client ID” (for example, 001: capital tie source, 002: stock issuer, 003: human relationship source, 004: purchaser, 005: distributor, 006: guarantor, 007: equity method parent company, 008, investor, 009: substantial controller, . . . 101: capital tie holder, 102: major stockholder, 103: human relationship holder, 104: supplier, 105: purchaser, 106, guarantee, 107: equity method affiliate, 108: investee, and substantial controlled company, . . . ). Note that, in a case where the client indicated by the “client ID” is a major company, null data or the like can be set in the “association type” as illustrated in FIG. 8. Furthermore, in FIG. 8, instead of or in addition to the “association type”, a data item for determination of the relationship between companies (for example, the investment ratio) can be provided to allow the association type to be determined in every case. Thus, the data item for determination of the relationship between companies can be used depending on the intended use; for example, in a case where a company holding a capital tie with a certain company is to be referenced, the data item for determination of the relationship between companies is used instead of the “association type”.

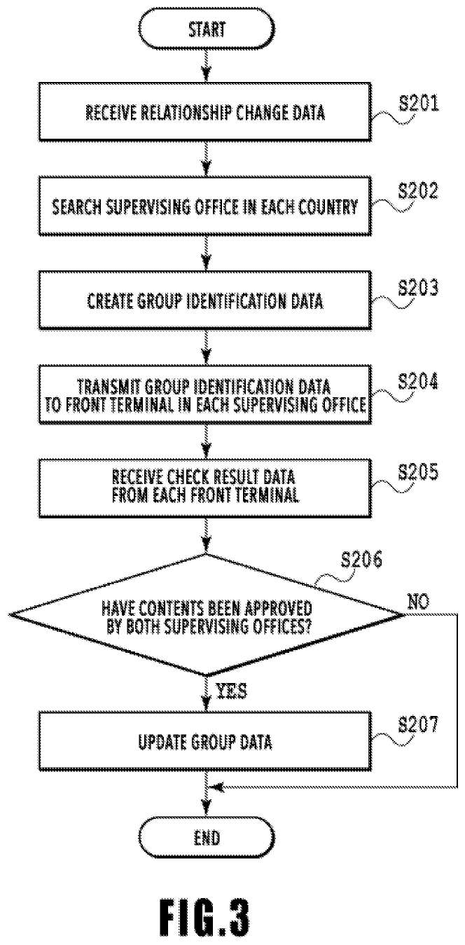

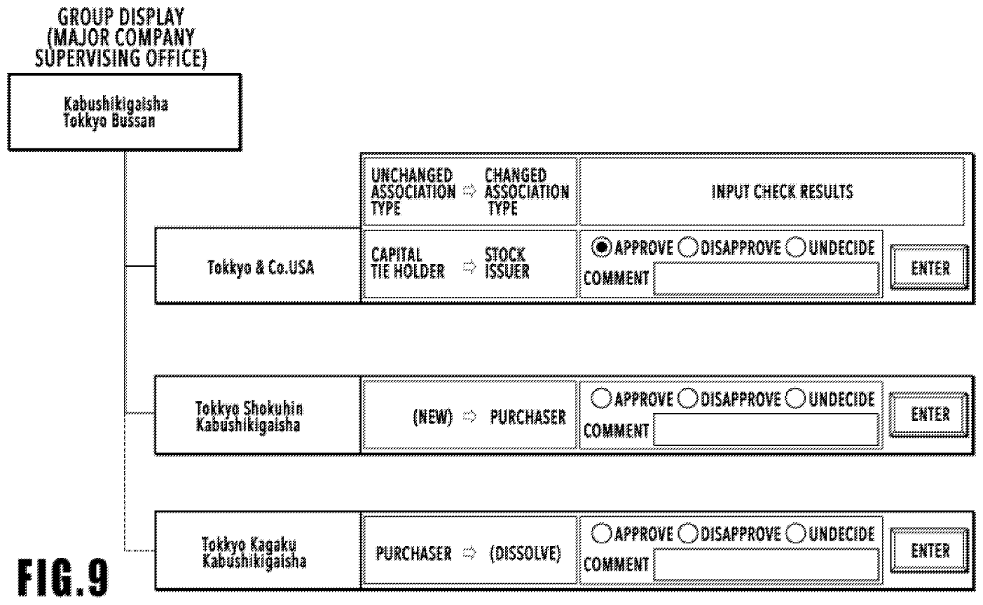

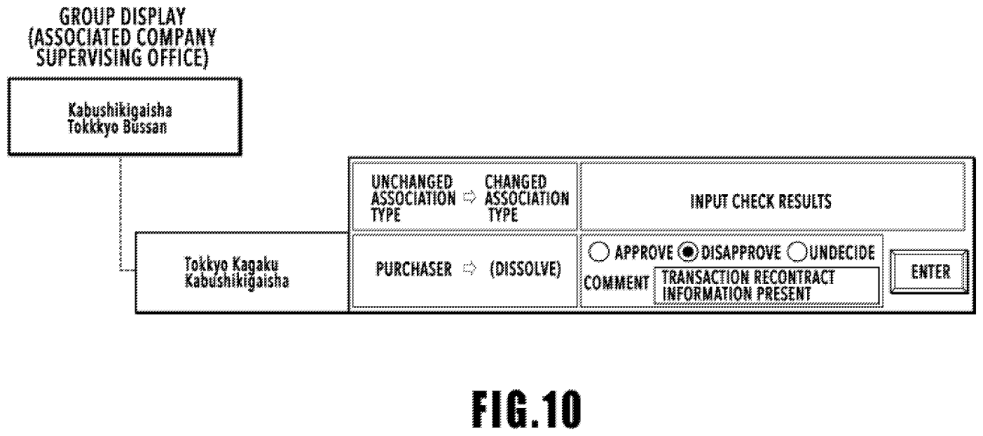

Now, a group identification process according to the present embodiment will be described along the flow of the process with reference to a flowchart in FIG. 3, data in FIGS. 4 to 8, and a user interface in FIGS. 9 and 10. FIG. 3 is a flowchart illustrating the group identification process according to the embodiment of the present invention. In this process, the group management server 100 uses, as a trigger, reception of the company relationship change data to inquire of the supervising offices for the companies involved in the change about whether the contents for the change are correct or not, and in a case where all the supervising offices approve the contents, reflects the contents in the group data indicative of the relationship between the companies.

First, the data transmission and reception processing unit 120 receives the relationship change data (FIG. 5) from the external server 107 and stores the relationship change data in the relationship change data storage unit 131 (step S201). In this embodiment, the relationship change data is provided by the external server 107. In another embodiment, for example, the front operation terminal can input the relationship change data via, for example, a dedicated Web site provided by the group management server 100. In this case, the relationship change data is received from the front terminal 102 or from the front terminal 106 via the another-country server 104.

Then, the group identification processing unit 121 searches for the supervising office for each of the companies involved in the change in relationship (step S202). Specifically, the group identification processing unit 121 searches the “external ID” in the client data (FIG. 4) using each of the “association source company ID” and “associated company ID” in the relationship change data (FIG. 5) received in step S201, and identifies the supervising offices for the association source company and the associated company from the acquired “financial institution code” and “branch office code”. The client data about each company is pre-stored in the client data storage unit 130 of the group management server 100 or the storage unit of the another-country server 104. Which country includes a server computer in which the client data is stored depends on which country includes a supervising office with which each company deals.

Then, the group identification processing unit 121 creates group identification data (FIG. 6) to be provided to each supervising office for a check, and stores the group identification data in the group identification data storage unit 132 (step S203). In the example in FIG. 6, for each associated company, data indicative of a relationship with the major company is created according to an embodiment. Specifically, the “supervising office code” in the group identification data is created from a combination of the “financial institution code” and the “branch office code” in the client data (FIG. 4) about the association source company or associated company acquired in step S202. Similarly, the “client ID”, the “client name”, the “account type”, and the “account number” in the group identification data are created from the data items with the same names in the client data about the associated company. Note that which of the association source company and the associated company is defined as the major company or the associated company depends on which of the association source company and the associated company is defined as a reference (major company).

The “major company ID” in the group identification data is intended to identify the major company. Thus, in the example in FIG. 6, the “major company ID” is created from a combination of the “financial institution code” and the “branch office code” in the client data about the association source company or associated company defined as the major company, “-” (hyphen), and the “client ID”. This is because even the same client has independent “client IDs” in different countries, thus possibly precluding the client from being uniquely identified simply by using the “client ID” (for example, a certain client ID may indicate different clients in a country A and in a country B).

The “external ID” and the “changed association type” in the group identification data are each created from the “association source company ID” and the “association source association type” or the “associated company ID” and the “associated company association type” for the major company, the company IDs and the association types being included in the relationship change data (FIG. 5). On the other hand, the “unchanged association type” is the current association type and is thus created from the “association type” acquired by using, as a search key, the “association source company ID” or the “associated company ID” for the major company to search the “external ID” in the group data (FIG. 8) indicating the current relationship between the companies Furthermore, the “ID” in the group identification data is created by, for example, assigning a number allowing this data to be uniquely identified (for example, a sequence number) in a case where the data is created.

Then, the data transmission and reception processing unit 120 transmits the group identification data (FIG. 6) created in step S203, to the front terminal 102 and/or the front terminal 106 of the major company and the associated company in order to inquire about whether the contents for the change are correct or not (step S204). In an embodiment, user interfaces as illustrated in FIG. 9 and FIG. 10 are displayed at a dedicated Web site provided by the group management server 100, and the teller of each supervising office performs a check via the corresponding front terminal.

FIG. 9 is a diagram illustrating a user interface for checking of group identification candidates (for the major company supervising office) according to the present embodiment. An example in FIG. 9 indicates that the relationship between the major company “Kabushikigaisha Tokkyo Bussan” and three associated companies has changed. The teller of the supervising office for the major company checks the major company and the associated companies involved in change, whether the changed association type is correct, and the like, and inputs check results (approval or disapproval, a comment, and the like). On the other hand, FIG. 10 is a diagram illustrating the user interface for checking of group identification candidates (for the associated company supervising office) according to the embodiment of the present invention. The teller of the supervising office for the associated company similarly checks, via the front terminal, whether the contents for the change are correct or not, and inputs check results.

Then, the data transmission and reception processing unit 120 receives the check result data (FIG. 7) from the supervising offices for the major company and the associated companies through the front terminal 102 and/or the front terminal 106, and stores the check result data in the storage unit 133 (step S205). The check result data is the check results for the group identification data (FIG. 6) transmitted in step S204 and can be linked with other check result data using the “IDs” for the respective data. In a case where the check result data for the group identification data is received from the supervising offices of both the major company and each associated company, the process transitions to step S206.

Based on the “major company results” and the “associated company results” in the check result data (FIG. 7) received in step S205, the group data update processing unit 122 determines whether the supervising offices of both the major company and each associated company have approved the contents for the change or not. In the example in FIG. 7, in a case where both the “major company results” and the “associated company results” indicate “1” (approved), both supervising offices are determined to approve the contents. In this case, the process proceeds to a Yes route of step S206, and the group data update processing unit 122 updates the group data (FIG. 8) stored in the group data storage unit 134, in accordance with the “unchanged association type” and the “changed association type” in the approved group identification data (FIG. 6) (step S207). After step S207, the process ends.

Step S207 will be described in further detail. In a case where the “unchanged association type” in the group identification data (FIG. 6) indicates “000” (no association), this means that the associated company has newly become a purchaser of the major company with which the associated company was originally unassociated (“changed association type” indicates “105”). Based on the group identification data, a new record is created in the group data (FIG. 8).

On the other hand, in a case where the “unchanged association type” in the group identification data (FIG. 6) indicates “000” (no association), this means that the association between the associated company and the major company has been lost in which the associated company is a purchaser of the major company, and the corresponding record for the group data (FIG. 8) is deleted.

In a case where both the “unchanged association type” and the “changed association type” indicate a value other than “000” (no association), this means that the association type between the companies has changed, and the “association type” in the group data is updated with the “changed association type”.

Furthermore, in step S206, in a case where neither of the supervising offices for the major company and each associated company has approved the contents for the change, the process proceeds to a No route, and the process ends. In this case, the supervising offices for both the major company and each associated company, credit departments, and the like can be fed back with the disapproval. Thus, the teller or the personnel of the credit departments can check the disapproved contents for the change to take corrective measures. For example, in a case where the contents for the change are incorrect, modified relationship change data is input via the dedicated Web site as described for step S201, and the process is executed again in order to inquire of each supervising office about whether the contents for the change are correct or not.

Moreover, based on the “association type” or the data item for determination of the relationship between companies (for example, the investment ratio), which are included in the updated group data (FIG. 8), data about companies can be variably extracted, the companies having a particular relationship corresponding to the purpose of the data item, for example, a relationship related to capital, stock issuer/major stockholder, human relationship, supply, distribution, equity method company, investment, and substantial control. Accordingly, executives and departmental personnel of a financial institution, the entire financial holding company group including the financial institution, and affiliated companies can extract and format, as necessary, data about companies having a particular relationship corresponding to a purpose instead of referencing established data as in the related art, and can make the institution's managerial determinations and decisions. More specifically, for example, an executive of the financial institution or the financial holding company group utilizes a computer terminal to access the dedicated Web site provided by the group management server 100 and selects a particular relationship on the Web site. Then, the group management server 100 uses the specified (selected) relationship as a search key to search for the “association type” or the data item for determination of the relationship between companies, and extracts the data related to the companies having the particular relationship. Furthermore, the extracted data is formatted according to the purpose, and the resultant data can be referenced on the Web site and downloaded.

As described above, the computing system centrally manages data about a business client and group companies thereof which data is used in a financial institution or a financial holding company group to allow supervising offices to share the data, thus enabling accurate and efficient understanding of change information about capital ties among corporations and the like. In particular, in a case where the capital tie between the companies or the like is changed, each of the supervising offices is made to check the contents for the change based on a relationship between the supervising office and the business client thereof and a relationship between a branch office and a business client thereof. Determination information about whether corporate group data needs to be updated or not is provided to allow the corporate group data to be updated to a latest status. Furthermore, the latest corporate group data constantly updated as described above is utilized to allow the financial institution or the financial holding company group to know the statuses of transactions of the business client and all the group companies thereof.

1. A server computer that centrally manages data about a business client and group companies thereof which data is used in a financial institution or a financial holding company group including the financial institution, the server computer being configured to:
receive relationship change data related to contents for a change in a relationship between the business client and each of the group companies;
search for supervising offices in the financial institution or the financial holding company group for the business client and the group companies respectively based at least on the relationship change data and client data, the client data being data related to contracted clients including the business client and the group companies, the financial institution or the financial holding company group dealing with the contracted clients;
create group identification data used to inquire of each of the supervising offices about whether the contents for the change are correct or not, based at least on the relationship change data and the client data, the group name identification data being data related to contents for the relationship between the business client and each of the group companies before and after the change;
transmit the group identification data to terminals of the supervising offices;
receive check result data from the terminals of the supervising offices, the check result data being data related to results of checks on the group identification data by the supervising offices;
determine, based at least on the check result data, whether each of the supervising offices approves the group identification data; and
update group data based at least on the group identification data in a case where each of the supervising offices approves the group identification data, the group data being data related to a current relationship between the business client and each of the group companies.

2. The server computer according to claim 1, further configured to transmit the group identification data to the terminals of the supervising offices includes providing a Web site to the terminals of the supervising offices, and wherein a user interface indicating the relationship between the business client and each of the group companies is displayed at the Web site to make personnel of each of the supervising offices check the group identification data and input the check result data.

3. The server computer according to claim 2, further configured to receive the relationship change data includes receiving the relationship change data from a computer managed by an institution other than the financial institution and the financial holding company group or from the terminals of the supervising offices via the Web site.

4. The server computer according to claim 1, wherein the supervising offices are located in different countries, and the client data about the business client and the group companies is held by computers in countries where the supervising offices corresponding to the business client and the group companies are located.

5. The server computer according to claim 1, further configured to:
receive specification data specifying a relationship between the business client and each of the group companies, from a first computer utilized by personnel of the financial institution or the financial holding company group; and
extract the business client and the group company having a particular relationship based on the specification data and the group data.

6. The server computer according to claim 1, wherein the relationship between the business client and each of the group companies in the relationship change data and the group data is related to one of capital, stock issuer/major stockholder, human relationship, supply, distribution, equity method company, investment, and substantial control.

7. A method executed by a server computer that centrally manages data about a business client and group companies thereof which data is used in a financial institution or a financial holding company group including the financial institution, the method comprising the steps of:
the server computer receiving relationship change data related to contents for a change in a relationship between the business client and each of the group companies;
the server computer searching for supervising offices in the financial institution or the financial holding company group for the business client and the group companies respectively based at least on the relationship change data and client data, the client data being data related to contracted clients including the business client and the group companies, the financial institution or the financial holding company group dealing with the contracted clients;
the server computer creating group identification data used to inquire of each of the supervising offices about whether the contents for the change are correct or not, based at least on the relationship change data and the client data, the group name identification data being data related to contents for the relationship between the business client and each of the group companies before and after the change;
the server computer transmitting the group identification data to terminals of the supervising offices;
the server computer receiving check result data from the terminals of the supervising offices, the check result data being data related to results of checks on the group identification data by the supervising offices;
the server computer determining, based at least on the check result data, whether each of the supervising offices approves the group identification data; and
in a case where each of the supervising offices is determined to approve the group identification data, the server computer updating group data based at least on the group identification data, the group data being data related to a current relationship between the business client and each of the group companies.

8. A non-transitory computer readable storage medium storing a computer executable instruction, when executed by a server computer that centrally manages data about a business client and group companies thereof which data is used in a financial institution or a financial holding company group including the financial institution, causing the server computer to perform the steps of:
receiving relationship change data related to contents for a change in a relationship between the business client and each of the group companies;
searching for supervising offices in the financial institution or the financial holding company group for the business client and the group companies respectively based at least on the relationship change data and client data, the client data being data related to contracted clients including the business client and the group companies, the financial institution or the financial holding company group dealing with the contracted clients;
creating group identification data used to inquire of each of the supervising offices about whether the contents for the change are correct or not, based at least on the relationship change data and the client data, the group name identification data being data related to contents for the relationship between the business client and each of the group companies before and after the change;
transmitting the group identification data to terminals of the supervising offices;
receiving check result data from the terminals of the supervising offices, the check result data being data related to results of checks on the group identification data by the supervising offices;
determining, based at least on the check result data, whether each of the supervising offices approves the group identification data; and
in a case where each of the supervising offices are determined to approve the group identification data, updating group data based at least on the group identification data, the group data being data related to a current relationship between the business client and each of the group companies.
